(19) United States
(12) Patent Application Publication
(10) Pub. No.: US 2025/0058911 A1
(43) Pub. Date: Feb. 20, 2025

(54) VENT TUBE APPARATUS, SYSTEM AND METHODS WITH TRACEABLE CAP FOR VENT TUBE INTRUSION DETECTION

(71) Applicant: ENPRO, INC., Addison, IL (US)

(72) Inventors: GRANT COOK, ST. CHARLES, IL (US); DANIEL NAMIE, ELBURN, IL (US)

(21) Appl. No.: 18/815,263

(22) Filed: Aug. 26, 2024

Related U.S. Application Data
(63) Continuation of application No. 18/244,666, filed on Sep. 11, 2023, now abandoned.
Application No. 18/244,666 is a continuation of application No. 18/078,532, filed on Dec. 9, 2022, now abandoned.
Application No. 18/078,532 is a continuation of application No. 17/541,940, filed on Dec. 3, 2021, now abandoned.
Application No. 17/541,940 is a continuation of application No. 17/183,113, filed on Feb. 23, 2021, now abandoned.
Application No. 17/183,113 is a continuation of application No. 16/707,956, filed on Dec. 9, 2019, now abandoned.
Application No. 16/707,956 is a continuation of application No. 15/645,716, filed on Jul. 10, 2017, now Pat. No. 10,745,154.
Application No. 15/645,716 is a continuation-in-part of application No. 14/591,237, filed on Jan. 7, 2015, now abandoned.
Application No. 14/591,237 is a continuation-in-part of application No. 14/268,769, filed on May 2, 2014, now Pat. No. 9,388,920.
Application No. 14/268,769 is a continuation of application No. 12/984,414, filed on Jan. 4, 2011, now Pat. No. 8,739,841.
(60) Provisional application No. 61/335,258, filed on Jan. 4, 2010.

(51) Int. Cl. B65B 3/18; B65B 57/00; B67C 3/00; B67C 3/26

(52) U.S. Cl. CPC B65B 3/18; B65B 57/00; B67C 3/007; B67C 2003/2602

(57) ABSTRACT

The present disclosure is directed to a non-traceable vent tube and a traceable vent tube cap apparatus, system and methods incorporating a traceable material such as a Radio Frequency Identification (RFID) tag or a magnet for use in conjunction with a filling machine during container filling operations for a quicker and more accurate detection of the location of the non-traceable vent tube or the traceable vent tube cap after becoming detached from a filling machine during filling operations, and to increase the safety of the filling operation and reduce costs and time when a malfunction occurs.

### PRIORITY STATEMENT

This application is a continuation of U.S. patent application Ser. No. 18/244,666, filed Sep. 11, 2023, now pending, which is a continuation of U.S. patent application Ser. No. 18/078,532, filed Dec. 9, 2022, now abandoned, which is a continuation of U.S. patent application Ser. No. 17/541,940, filed Dec. 3, 2021, now abandoned, which is a continuation of U.S. patent application Ser. No. 17/183,113, filed Feb. 23, 2021, now abandoned, which is a continuation of U.S. patent application Ser. No. 16/707,956, filed Dec. 9, 2019, now abandoned, which is a continuation of U.S. patent application Ser. No. 15/645,716, filed Jul. 10, 2017, now U.S. Pat. No. 10,745,154, issued Aug. 18, 2020, which is a continuation-in-part of U.S. patent application Ser. No. 14/591,237, filed Jan. 7, 2015, now abandoned, which is a continuation-in-part of U.S. patent application Ser. No. 14/268,769, filed May 2, 2014, now U.S. Pat. No. 9,338,920, issued Jul. 12, 2016, which is a continuation of U.S. patent application Ser. No. 12/984,414, filed Jan. 4, 2011, now U.S. Pat. No. 8,739,841, issued Jun. 3, 2014, which is a continuation of U.S. Provisional App. 61/335,258 filed Jan. 4, 2010, now expired. All of which are hereby incorporated by reference in their entirety as though fully set forth herein.

### FIELD OF THE DISCLOSURE

The present disclosure relates to traceable vent tubes and removable vent tube tips or caps incorporating one or more detectors or indicators for use in conjunction with a filling machine during container filling operations to increase the safety of the filling operation and reduce the associated cost and time when a malfunction occurs. In particular, the present disclosure relates to food or beverage vent tubes and removable vent tube tips incorporating a magnet or a Radio Frequency Identification (RFID) tag and can incorporate other types of tags or traceable material allowing for a quicker and more accurate detection of an intrusion (and the location) of a food or beverage vent tube that has become detached from a filling machine during filling operations.

### BACKGROUND OF THE DISCLOSURE

In the food and beverage industry there is a need for efficient and reliable manufacturing processes to quickly and safely manufacture and package the food and beverage product. Most food and beverage plants across the United States run continuously, 24 hours a day and 7 days a week, to meet the ever increasing demands. With these stringent demands on their machines as well as personnel, most food and beverage plants have implemented some form of process control or automation. By using programmable logic controllers (PLCs) and various other logic controlling devices, elementary applications that used to require manual attention can now be done with machines.

In particular, the demand today for beverage containers filled with product, such as cola and beer, is greater than it has ever been and continues to grow. These containers can be glass bottles, aluminum cans or any type of canister that can store, for example, consumable beverages, automobile product, hair and skin care product, and any other liquid or semi-liquid product that is packaged and distributed in such a container. These container packages can be any size and shape, such as those found in 12 ounce cola or beer cans and bottles, and the various bottles containing hair care product.

These containers can be made from many different materials, such as glass, plastic, aluminum, tin among others, and are enclosed, after being filled with product, using a type of cap or top attached by screwing onto the container, crimping, pressing or heat sealing, or in other ways to enclose the product in the container.

In order to meet this demand for liquid and semi-liquid product, high speed, automatic filling machines are incorporated in the filling process. These automatic machines can load, fill, enclose, and box up thousands of these containers each minute in a high-speed operation. These automatic filling machines load the empty containers onto a conveyor and move the bottles into a location on the machines where the containers come in contact with the filling machine and are filled with product. Once filled, the containers are enclosed or sealed and are quickly moved away from the filling station, and boxed up or packaged along with other filled containers to be shipped or distributed to retail centers and the like.

In such a high-speed operation, when an accident or mistake occurs, hundreds or thousands of containers may inadvertently be filled before the filling machine or process can be halted. In these situations, the hundreds or thousands of containers filled after the accident may need to be discarded, wasting time and money to determine which bottles were filled after the accident.

The fill process will vary depending on the product being filled, and various factors, such as the temperature and viscosity of the product, the beverage gas, the effect of those gases and related pressure characteristics during the filling process. Accordingly, the filling process and related conditions can be optimized and maximized monitoring and controlling these factors. For purposes of this application and for simplicity, most of the examples herein will refer to a carbonated beverage filling process, although the apparatus, system and methods described herein relate to any similar type of filling process.

Further, the filling process can not alter the food or beverage being filled. Thus, when planning a filling system it is important to match the appropriate filling steps to the beverage characteristics and container. The steps of the filling process include some or all of the following: evacuation of the container, flushing the container with gas, pressurizing the container with gas, filling the container with one or multiple speeds, fill level correction (in certain cases), and settling the product.

Evacuation is used mostly on rigid containers in which a vacuum process removes upwards of 90% of the air content in the container prior to pressurizing with gas. Evacuation becomes more important when the contents being filled are oxygen sensitive and they may be repeated at other times throughout the filling process. Additionally or alternatively, the container may be flushed with gas. This is done mostly with flexible containers, such as PET bottles and aluminum cans, which may not be able to withstand a vacuum. The flushing step takes place at the time that the fill valve is located at the container and usually uses gas from the filling ring bowl until both pressures are the same.

Next, filling takes place when the fill valve opens and the product flows over and around the vent tube and into the container. As the container fills, gas in the containers is displaced by the product and flows through the vent tube and out of the container into the filler ring bowl, until the container is full. As an example, the vent tube may contain an electronic probe to detect product and stop filling. Accordingly, the vent tube vents the gases being used while filling the container with fluid. The process needs to be extremely accurate, and as a result most vent tubes are designed at specific lengths to achieve each specific fill level per filling machine.

Fill level correction may be incorporated when the cost of product is high to save product. In the most commonly used fill level correction step, the container is first overfilled with product and then the product is extracted using a vacuum through the vent tube. Finally, by settling, the pressure in the container is lowered and the beverage is allowed to settle as it is lowered from the fill valve.

The vent tubes used in the filling process described above usually are configured with an elongated, hollow, cylindrical tube extending the length of the tube which allows the vent tube to enter the container opening during the fill process without touching the container. As described above and in U.S. Pat. No. 3,736,966, which is incorporated by reference herein, the product can flow over the vent tube into the container. The lower tip of the vent tube is usually closed and one or more holes are provided so that any gas or air in the container can be displaced through the vent tube during the filling process, minimizing or eliminating the possibility of a container exploding during filling

Traditionally, filling machines for glass containers use a vent tube made of stainless steel or a stainless food-grade plastic hybrid. For filling aluminum containers, the vent tube is usually made from some form of food-grade plastic, such as Delrin®. Vent tubes can also use a ball and cage system as described in U.S. Publication No. US20050199314 Al, which is incorporated by reference herein.

In certain instances, the high speed automatic filling machines allow for removing and replacing the vent tube or a portion of the vent tube, such as the cap, as described in U.S. Pat. Nos. 4,049,030 and 5,878,797, which are incorporated by reference herein. In other situations, a removable vent tube cap or tip can be attached, either by using threads on the cap, a slot, a snap-in configuration or some other manner, as understood by one having ordinary skill in the art.

Due to the high speeds and constant use of these filling machines, occasionally a vent tube may detach from the filling machine and fall into the product container. When this event occurs there are minimal systems in place to halt the filling process, locate the detached vent tube or portion thereof (such as a cap), repair the filling machine and begin the process again. Each minute that the process is halted equates to thousands of unfilled containers, as filling machines can run at speeds of 1650 cans per minute. Further, the longer the process continues, the more filled containers that will have to be examined to find the detached vent tube. In many situations, the containers filled with product that were boxed up or packaged after the vent tube became detached are merely discarded, increasing the costs of the accident.

Some of the current systems used to check for detached stainless steel vent tubes include the use of inductive or capacitive sensors, vision systems or other ultrasonic inline systems. Additionally, systems for determining when a vent tube has become detached and fallen into the container include the electromagnetic detection fields or X-ray based technologies. Some of the manufactures of these technologies include Omron Corporation, Industrial Dynamics Company, and the Fortress Technology Inc., among others.

However, most of these inspection systems need to have direct access to each and every container after it has been filled with product, and are used as a way to detect the vent tube by examining each container. This process either slows down the filling line because each and every container must be examined, or takes longer time than necessary to find the container in which the vent tube has fallen if each container has not been examined.

Further, some of the systems work better with metal vent tubes, while other systems work better with plastic vent tubes creating inconsistencies, or the need for additional equipment when changing to different vent tubes. For example, when a plastic vent tube falls into a can made of aluminum at a filling plant, the inductive and capacitive technologies cannot detect the plastic vent tube (foreign) object through the aluminum can.

There is currently no apparatus, system or method that incorporates an indicator, such as an RFID tag or a magnet, into a vent tube or a replaceable vent tube cap for use during filling operations, that increases the safety of the filling operation and reduces the costs and time when a malfunction occurs, such as when a vent tube detaches from the filling machine and falls into the container. There is also no apparatus, system or method relating to vent tubes or vent tube caps incorporating an RFID tag or a magnet that allows for a quicker and more accurate determination of the location of a vent tube that has become detached from a filling machine during filling operations. The present disclosure satisfies these needs.

### SUMMARY OF THE DISCLOSURE

In order to solve the above-mentioned shortcomings in filling operations, the present disclosure utilizes apparatus, system and/or methods for determining the location of a vent tube or a replaceable vent tube cap when the vent tube malfunctions and becomes detached from a filling machine and, in special cases, falls or intrudes into a container being filled. In particular, the disclosure utilizes a vent tube or vent tube cap modified with a traceable material, such as an RFID tag or a magnet, and can incorporate a system and methods for scanning a filling machine, as well as food or beverage containers, using sensing technologies, such as RFID or magnetic technologies.

The present disclosure solves the problems facing the packaging industry, and in particular, the beverage filling industry as described above. The present disclosure incorporates a solution for consistent detection of vent tube intrusion into a container, which exceeds the current standards at specific beverage manufacturing plants.

The present disclosure incorporates a solution for a vent tube by allowing for a replaceable vent tube cap containing a traceable material, such as a magnet or an RFID tag, to be attached to a vent tube thereby providing a consistent detection of inadvertent vent tube intrusion into a container, which exceeds the current standards at specific beverage manufacturing plants.

At large automated beverage manufacturing plants, aluminum cans are a commonly used container for product. As described above, when a plastic vent tube falls into aluminum can as it is being filled, the inductive and capacitive technologies normally used to detect metal vent tube, cannot detect the plastic foreign object through the aluminum can. As a result expensive X-ray systems are used or product is considered waste.

The present disclosure solves this inherent problem by incorporating or implementing an RFID tag or a magnet into each vent tube or replaceable vent tube cap and utilizing an associated monitoring system. The incorporated RFID tag or magnet can be used on metal, metal-plastic hybrid, ball cage, and plastic vent tubes or replaceable vent tube caps with the same result. By placing an in-line identification gate or RFID or magnetic scanner or reader after the filling process occurs, and a continuous monitoring system on the filling machine any such vent tube or vent tube cap can be reliably tracked if it becomes detached from the filling machine during the filling process.

By tagging the vent tube or replaceable vent tube cap with an RFID transponder, magnet or other tagging technologies, routine consistency checks will not have to be performed. Further, other materials may now be considered as containers for the packaging side of the manufacturing facilities.

The vent tube detection system used in conjunction with the present disclosure has several components, such as chips, tags, readers and antennas. By incorporating an RFID tag, magnet or transponder or other tagging technology into the vent tube, the vent tube or vent tube cap can be tracked using the same transponder or tag reading system as described above. Since, in the case of an RFID tag, the transponder is created by attaching a small silicon chip to a small flexible antenna, the chip can be used to record and store information. To read the transponder and locate the specific vent tube, the RFID reader sends out a radio signal to be absorbed by the antenna and reflected back as a return signal delivering information from the transponder chip memory.

In use, the container filling machine operates in its normal manner with empty containers sent down a conveyor to the filling section of the system. The vent tube is then lowered (or the empty container is raised) to come in contact or near contact with the container. The container is filled with the product as described above, and the vent tube is separated from the filled container. The filled container is then covered and/or sealed. This filling process fills thousands of containers each minute. In the present disclosure, a traceable vent tube cap can be attached to an existing vent tube to allow standard vent tubes to become traceable vent tubes.

If, during these high-speed operations, a vent tube malfunctions (i.e., detaches or sheers from the filling machine, and falls into the container), the RFID transponder or magnet incorporated into the vent tube or replaceable vent tube cap will likewise fall into the filled container. Using the vent tube detection system, the system can have immediate information that the vent tube has detached from the filling system and precisely which container the vent tube or vent tube cap is located. Depending on the type of system and the indicator being used, the reader of the vent tube detection system can be anywhere from 1 foot to 20 to 30 feet from the location of the container or filling machine. Further, handheld RFID tag or magnetic readers can be used at the time of the malfunction to assist in finding the broken vent tube.

The vent tube or vent tube cap detection system can be set up at various locations in the filling plant in order to make sure that a vent tube or vent tube cap has not been accidentally been misplaced into a filled container before the container is shipped out of the plant.

These and other aspects, features, and advantages of the present disclosure will become more readily apparent from the attached drawings and the detailed description of the preferred embodiments, which follow.

### DRAWINGS

The preferred embodiments of the disclosure will be described in conjunction with the appended drawings provided to illustrate and not to the limit the disclosure, where like designations denote like elements, and in which:

FIG. 1 illustrates a filling machine in accordance with one embodiment of the present disclosure;

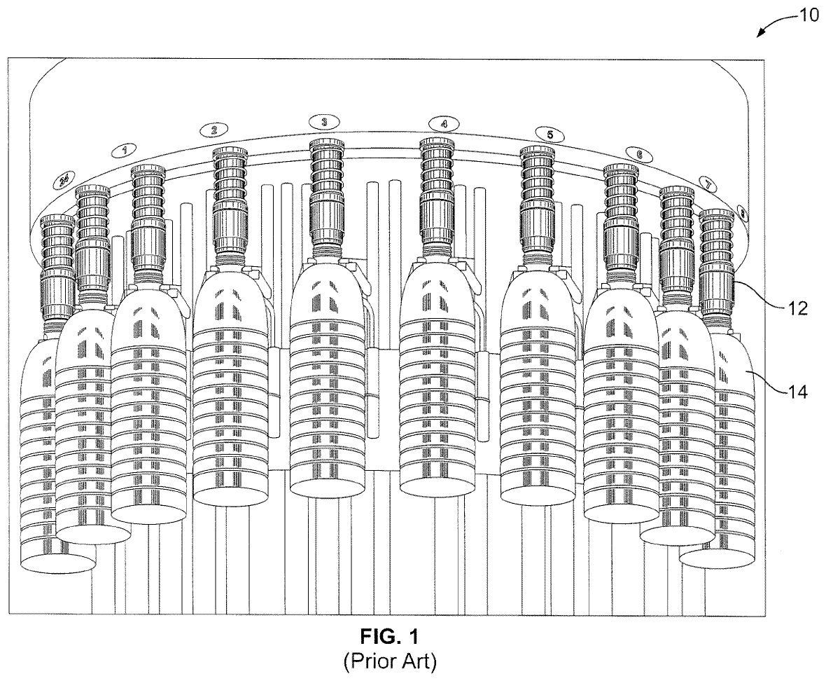

FIG. 2 illustrates an inspection system for inspecting empty and full containers in accordance with the present disclosure;

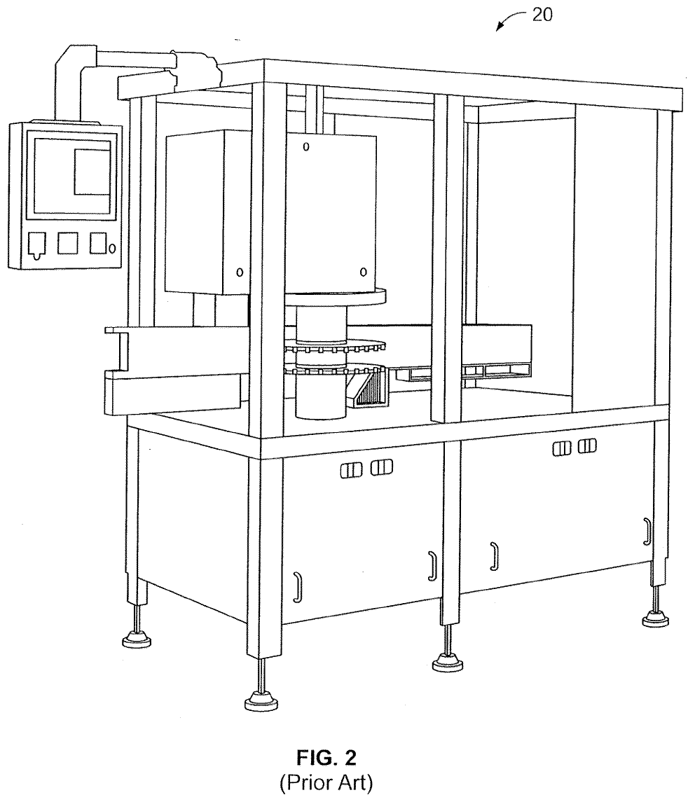

FIGS. 3A and 3B illustrate a vent tube incorporating indicators in accordance with an embodiment of the present disclosure;

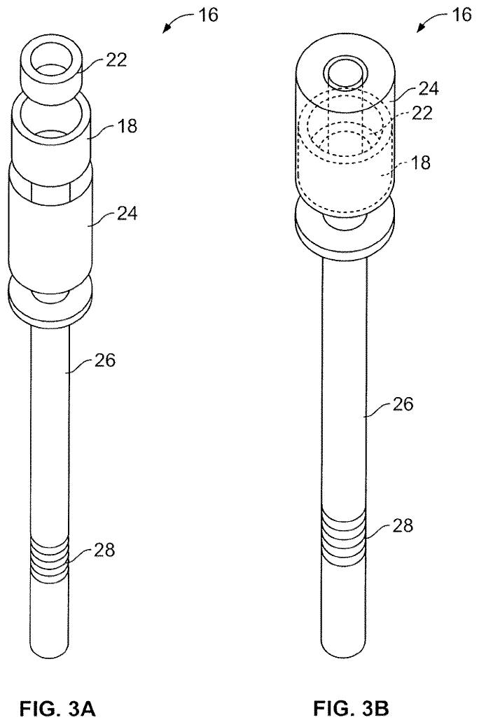

FIG. 4 illustrates an exemplary indicator detection system in accordance with an embodiment of the present disclosure; and

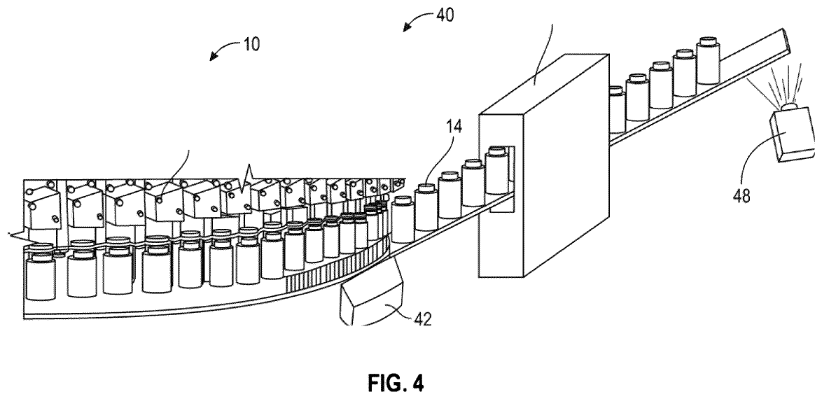

FIG. 5 illustrates an exemplary replaceable and/or traceable vent tube cap incorporating an indicator in accordance with an embodiment of the present disclosure.

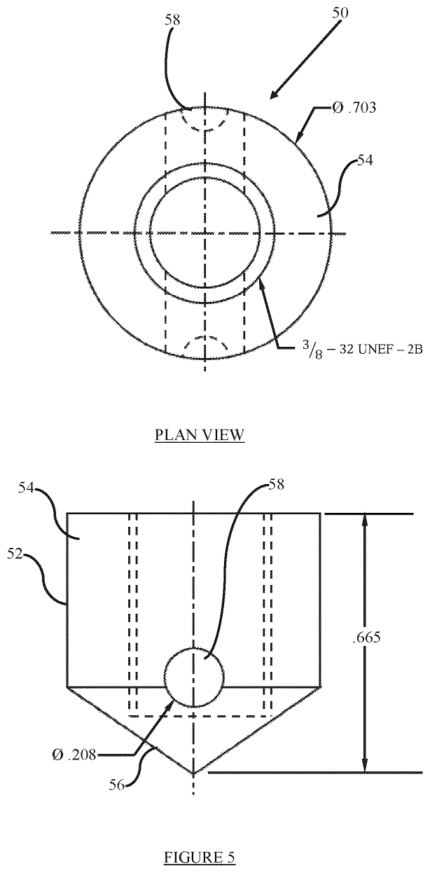

1. A traceable vent tube cap apparatus for use in filling a container in a filling machine in which a non-traceable vent tube is attached to the filling machine, and is configured to vent a gas from the container during the filling process, comprising:
a traceable vent tube cap, said traceable vent tube cap being hollow and configured to vent a gas from the container during the filling process, said traceable vent tube cap being configured to be attached to an existing non-traceable vent tube; and
an indicator, said indicator being housed in said traceable vent tube cap, such that if said non-traceable vent tube or said traceable vent tube cap detaches from said filling machine, said non-traceable vent tube or said traceable vent tube cap can be detected using an indicator detection system.

2. The traceable vent tube cap apparatus in claim 1, wherein said indicator is a magnet and said indicator detection system can detect magnets.

3. The traceable vent tube cap apparatus in claim 1, wherein said container is a glass bottle or an aluminum can.

4. The traceable vent tube cap apparatus in claim 1, wherein said indicator is a Radio Frequency Identification tag and said indicator detection system is a Radio Frequency Identification reader.

5. The traceable vent tube cap apparatus in claim 1, wherein said container is a glass bottle or an aluminum can.

6. The traceable vent tube cap apparatus in claim 1, wherein said during the filling process means as a product enters the container.

7. The traceable vent tube cap apparatus in claim 1, wherein said housed in said vent tube head means enclosed during an injection molded process.

8. The traceable vent tube cap apparatus in claim 1, wherein said housed in said vent tube head means attached during a machining process.

9. A container filling system for use in filling a container in which a non-traceable vent tube is attached to a filling machine, a traceable vent tube cap is attached to said non-traceable vent tube, and said non-traceable vent tube and traceable vent tube cap are configured to vent a gas from the container during the filling process, and the system is configured to determine when said non-traceable vent tube or traceable vent tube cap malfunctions, comprising:
a non-traceable vent tube, said non-traceable vent tube being hollow and configured to vent a gas from the container during the filling process, a traceable vent tube cap, said traceable vent tube cap attached to one end of said non-traceable vent tube, said traceable vent tube cap having an indicator, said indicator being housed in said traceable vent tube cap; and
an indicator detection system, said indicator detection system comprising a detector, such that if said non-traceable vent tube or said traceable vent tube cap detaches from said filling machine, said non-traceable vent tube or said traceable vent tube cap can be detected using said indicator detection system.

10. The container filling system in claim 9, wherein said indicator is a magnet and said indicator detection system can detect magnets.

11. The container filling system in claim 9, wherein said container is a glass bottle or an aluminum can.

12. The container filling system in claim 9, wherein said indicator is a Radio Frequency Identification tag and said indicator detection system is a Radio Frequency Identification reader.

13. The container filling system in claim 9, wherein said container is a glass bottle or an aluminum can.

14. The container filling system in claim 9, wherein said during the filling process means as a product enters the container.

15. The container filling system in claim 9, wherein said housed in said vent tube head means enclosed during an injection molded process.

16. The container filling system in claim 9, wherein said housed in said vent tube head means attached during a machining process.
